(19) United States
(12) Patent Application Publication
(10) Pub. No.: US 2014/0173081 A1
(43) Pub. Date: Jun. 19, 2014

(54) Method and apparatus for discovery and enumeration of sequentially networked devices

(71) Applicants: Joshua P. Knapp, Dorr, MI (US); Benjamin P. Knapp, Dorr, MI (US)

(72) Inventors: Joshua P. Knapp, Dorr, MI (US); Benjamin P. Knapp, Dorr, MI (US)

(21) Appl. No.: 14/078,757

(22) Filed: Nov. 13, 2013

Related U.S. Application Data
(60) Provisional application No. 61/725,531, filed on Nov. 13, 2012.

(51) Int. Cl. H04L 12/24

(52) U.S. Cl. CPC H04L 41/12
USPC 709/223

(57) ABSTRACT

A system and method that automates assigning unique IDs to sequentially networked devices. The system also allows for the discovery of the number of devices on the network as well as the type of these devices, as well as placing terminations. Each node has a switch that can disable all downstream communications. Nodes power-up with the switches closed. A controller broadcasts for all switches to be opened. Then the controller repetitiously orders each node with unassigned ID to take the current ID, close its switch and respond. This process continues until all nodes have an ID. Network terminations can be switched in either automatically, or by command from the controller wherever the end of the network is during the ID process.

This application is related to, and claims priority from, U.S. provisional patent application No. 61/725,531 filed Nov. 13, 2012. Application 61/725,531 is hereby incorporated by reference in its entirety.

### BACKGROUND

1. Field of the Invention

The present invention relates systems containing devices on a serial network and more particularly to a method and apparatus for discovery and enumeration of sequentially networked devices.

2. Description of the Prior Art

In a system of devices that are networked, it is often desirous to uniquely identify each device on the network. Some methods of setting the identity (ID) of the device involve setting jumpers on the devices circuit board or programming a number in the memory of the device. Some devices have a push button that will allow the ID to be set. All of these techniques require some intervention by an operator and therefore are cumbersome and subject to the possibility of an error in procedure. It is therefore desirous to automate the process of ID assignment. Some systems perform auto enumeration (auto addressing) using the “Bus Shunt Technique’ or BSM. This technique requires significant additional circuitry including current sources and differential amplifiers. Another technique for auto addressing is the “Extra Wire Daisy Chain” This method actually uses two connections in addition to the communication wire for every device. These wires are used to inefficiently convey information as to which device is in turn to get its ID. This method requires the wiring harness to contain an additional wire.

### SUMMARY OF THE INVENTION

The present invention automates the process of assigning unique IDs to sequentially networked devices. In addition the invention allows for the discovery of the number of devices on the network as well as the type of these devices. The present invention does not require any additional wires in the wiring harness. A single wire communication scheme with a standard bit format compatible with most microprocessor UARTs is typically used as a serial bus or serial communications network. The system and method of the present invention allows rapid and accurate self-identification of nodes on the network.

Each node has a switch that can disable all downstream communications. Nodes power-up with the switches closed. A controller broadcasts for all switches to be opened. Then the controller repetitiously orders each node with unassigned ID to take the current ID, close its switch and respond. This process continues until all nodes have an ID. Network terminations can be switched in either automatically, or by command from the controller wherever the end of the network is during the ID process.

### DESCRIPTION OF THE FIGURES

Attention is now directed to one or more figures that illustrate features of the present invention.

FIG. 1 shows an embodiment of the present invention on a single wire serial network.

FIG. 2 shows a block diagram of an embodiment of a controller.

Drawings and illustrations are provided to aid in understanding the present invention. The scope of the present invention is not limited to what is shown in the figures.

### DESCRIPTION OF THE PREFERRED EMBODIMENT

The present invention automates the process of assigning unique IDs to sequentially networked devices. In addition the invention allows for the discovery of the number of devices on the network as well as the type of these devices. In an automotive application, the physical interface typically is a LIN transceiver. The present invention can be employed on any communication network using any number of communications protocols or I/O transceivers. The description for a single wire communications scheme follows.

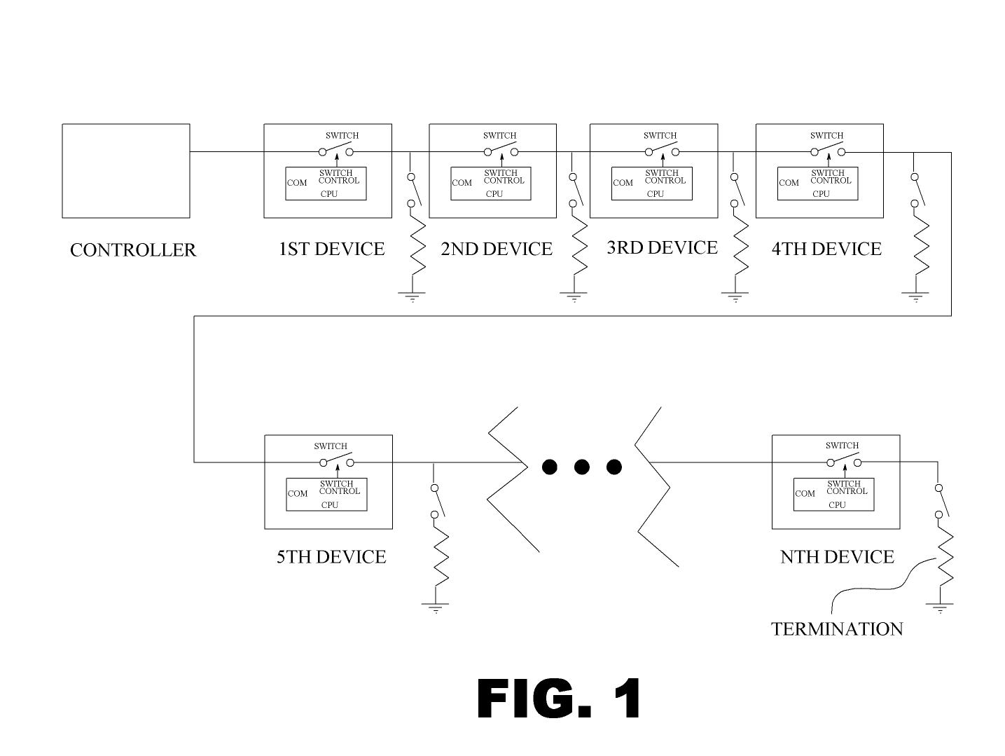

In the normal state, each node (device on the network) is able to communicate to any other device on the network. It is understood that there may be higher level protocols in place specifying at which time a particular node is allow to transmit, but electrically any node that does transmit will have its message seen by all the nodes on the system. Generally the first device is a master device and remaining devices are slaves. FIG. 1 shows an embodiment of the present invention. The controller is generally the first node on the network as shown in FIG. 1. Each slave device on the network has a connection for the input communications from the previous stage and an output connection for the next stage. According to the invention, each device is configured with an electronically controlled switch which can disable the connection between input and output. In the normal state the switch is closed and the input and output connections appear to be electrically the same. The preferred switch is an electronic analog switch; however, the switch can easily be constructed from logic gates or by any of a variety of techniques known in art. The switch allows bidirectional communications flow in the closed state and stops communications from a specific device to any other device further on the network in the open state.

To enumerate the devices, a command is sent from the master controller (PC or MCU etc.) telling the devices to open their respective switches. This command is considered a broadcast or global command because all devices carry out the command regardless of their respective IDs. It is preferred to send out this command several times (typically 3) with the devices designed to wait a small amount of time before carrying out this function (typically around 1 sec.) This allows for the contingency that if one or more of the devices misses the command, the communications link is not severed before additional requests can be seen downline. After the prescribed timeout, all of the devices outputs are switched off from communicating to the next device downline. In addition opening their respective switches, the devices reset their IDs to null. A zero ID is typical, but any number can be used to identify the device as not having an ID. It could also simply be marked by a flag in software, or by any other marking technique.

Next the controller sends a command (another broadcast command) asking for the first unassigned device on the system to take the device ID of ‘one’ (or any other unique ID number such as the number N, where N is a positive integer). The first device is the only device capable of seeing this command, because all subsequent devices have been cut off from communications. The device can either automatically respond that it took the ID, or the system can be designed to require a specific query by the controller. Either way, after the ID is assigned, the switch at the first node is then closed to allow communications to the next device (second device). The switch closure could happen automatically after ID assignment, or could be commanded by the controller. At this point both the first and the second device in the system will be able to ‘see’ communications coming from the master controller (or each other). The controller then commands any device on the system that does not have an ID to take the next unique ID. Typically, the next ID will be ‘two’. The commend can contain the next unique ID. The first and second device both see this command, but since the first device already has an ID, the second device is the only device that will accept the command. Again, after the assignment of an ID, the switch is closed to allow the next stage to be in communication (the third device in this example). This process continues until no device responds to taking the next unique ID. That indicates that all the devices have been assigned an ID. In practice it is preferred to have a process of timeouts and retries to make sure that a communication wasn't simply missed. At this point in the process, all devices on the network have been uniquely enumerated (given an ID) and can be individually commanded.

In addition to assigning addresses, the master controller has also learned the number of devices on the system. This allows for topologies in which the number of devices may be variable. The controller can use the knowledge of the number of devices, along with queries of the specific devices, to adapt the system or assign resources etc. For example, in a vehicle, perhaps one device is an optional inside cabin temperature sensor. The device could be placed anywhere in the chain of communications. Once the all of the devices are enumerated, the controller knows how many devices it needs to query. It can then ask each device what it is. The optional cabin temperature sensor would respond when queried and the controller would then know the unique ID that was assigned to the cabin temperature sensor. In a case like this, the enumeration and discovery process would not need to be done on a regular basis such as each time the vehicle was started. It could be done at the factory, or perhaps by a mechanic after repairs or maintenance had been done. In other types of systems where the changes to the number of devices or the device order on a network are more dynamic, it is necessary to perform the enumeration and/or discovery process anytime that all connected devices had to be guaranteed communication.

A particular advantage to the discovery technique of the present invention is to know where to place a termination component. For example, some types of communication links require that a termination resistor be placed on the communications line at the last device. A device could be provided with a programmable termination. The termination component could be enabled on a device by command of the master. Using the discovery technique of the invention, the master would know which device was the last one (or perhaps the last and middle one etc.), and could command only it to enable its termination. Another possibility is for the termination to be enabled on all devices during the command to open all switches. Then as devices are enumerated, the device just preceding the present device can be commanded to disable its termination. This would have the effect of making sure there was a continuous termination during the entire enumeration process.

While the examples presented relate to a single serial wire network, the method of the present invention may be applied onto serial parts of more complex network topologies. In particular, large networks may have parallel and serial parts. The enumeration and discovery technique of the present invention can be used with more complex protocols to discover and enumerate such a network. In that case, the serial part would be run separately several times in each of the parallel parts.

Embodiments of the invention may contain nodes that are directly connected to more than just two other nodes. In this case, a node may contain more than one switch. An example might be at a branch node in the network. Here a serial path could split into two or more other serial paths. This particular node could have two or more switches. The method used in this case would be very similar except that it would be employed down one of the serial paths until all the nodes on that path were identified and then be applied down the next serial path until all of the nodes on that path were identified. Such a node with more than one switch could identify itself to the controller once it takes an ID. The controller would then know to command it to close only one switch at a time, or the node CPU could be programmed to handle this task as if the entire network downstream were serial.

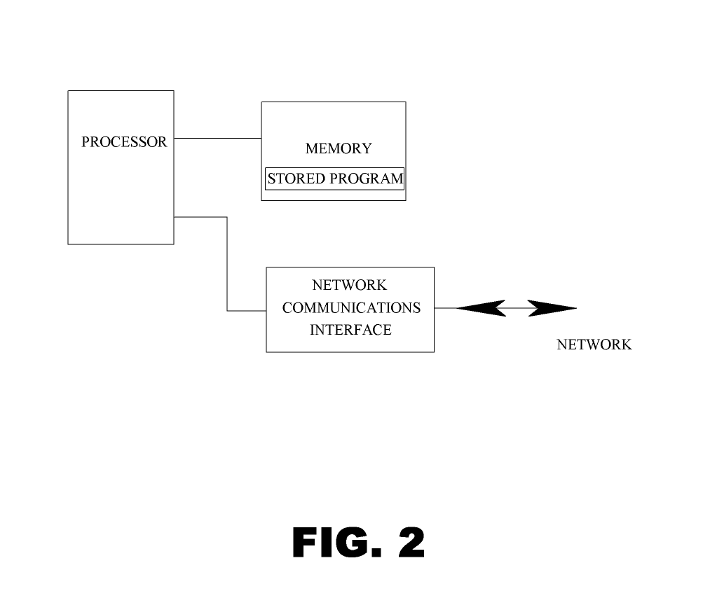

FIG. 2 shows an embodiment of a controller that includes a processor, a memory, network communication and a stored program in the form of executable instructions stored in the memory.

Several descriptions and illustrations have been provided to aid in understanding the present invention. One with skill in the art will realize that numerous changes and variations may be made without departing from the spirit of the invention. Each of these changes and variations is within the scope of the present invention.

We claim:

1. A method for enumerating nodes on a serial network where each node is equipped with a switch adapted to prevent communications on the network in a downstream direction from that node, the method comprising:
(a) causing all switches to opening;
(b) commanding any node with no identification (ID) assigned to take a next unique ID;
(c) at a node having just taken an ID, closing the switch at said node and sending notification of having taken an ID;
(d) repeating steps (b) and (c) until all nodes have unique IDs.

2. The method of claim 1 wherein the steps of causing, commanding and repeating are performed in a controller containing a processor with executable instructions and data stored in a memory.

3. The method of claim 2 wherein said controller logs how many nodes are on the network after all nodes have unique IDs.

4. The method of claim 1 where all nodes on the network have a network terminator in place upon power up, and each node removes said network terminator from the network upon taking an ID and closing its switch.

5. The method of claim 4 wherein said network terminators are resistors.

6. A method of assigning unique identifications to sequentially networked devices of the type where each device on the network has a switch preventing communications downstream from that device, said switches are closed on power-up, and a first sequential device is a controller, the method comprising:
a) said controller broadcasting an open-switch command over the network;
b) said controller setting a current identification (ID) to a predetermined number;
c) said controller broadcasting a command over the network causing a device with an unassigned ID to take the current ID and close its switch;
d) said controller listening on said network for a response from a device that has taken the current ID and closed its switch;
(e) incrementing the current ID;
(f) repeating steps c), d) and e) until no device on the network responds.

7. The method of claim 6 wherein said controller logs a count of how many devices are on said network.

8. The method of claim 6 further comprising said controller interrogating each device on the network for its device type.

9. The method of claim 6 wherein each of said devices has a line termination in place on power up, and after step d), said controller sending a command to the device that has just taken the current ID and closed its switch to remove its line termination.

10. The method of claim 9 wherein said line terminations are resistors.

11. The method of claim 1 where step a) is repeated N times before proceeding to step b), where N is a positive integer.

12. The method of claim 11 wherein N=3.

13. A serial communications system comprising:
a controller;
a plurality of nodes connected serially on a network to said controller, each of said nodes having a resettable identification (ID) value, and a switch that, when open, opens said network downstream from said node;
wherein each of said nodes powers-on with its particular switch closed and its ID value unassigned;
wherein said controller is configured to first broadcast a command over the network for a node to open its particular switch;
wherein said controller is further configured to second set a present ID value;
wherein said controller is further configured to broadcast a command over the network for a node with unassigned ID value to take the present ID value, and to close its switch;
wherein said controller is further configured to listen for a response from any node that has taken the present ID value;
wherein said controller continues to broadcast commands over the network for a node with unassigned ID value to take the present ID value and close its switch until no node responds to this command.

14. The serial communications system of claim 13 wherein said controller includes a processor and a memory and a set of executable instructions stored in said memory.

15. The serial communications system of claim 13 wherein each of said nodes includes a switchable network terminator adapted to be switched onto the network.

16. The serial communications system of claim 15 wherein each of said nodes is adapted to remove said network terminator upon command from the controller.

17. The serial communications system of claim 15 wherein said switchable network terminators are resistors.

18. The serial communications system of claim 13 wherein said controller is adapted to log how many devices are on the network after no node responds to a command to take the present ID value.
